(19) United States
(12) Patent Application Publication
(10) Pub. No.: US 2004/0120649 A1
(43) Pub. Date: Jun. 24, 2004

(54) Optical coupling interface for optical waveguide and optical fiber

(75) Inventors: Tomasz Klosowiak, Glenview, IL (US); Lawrence Lach, Chicago, IL (US); Robert Lempkowski, Elk Grove Village, IL (US)

Correspondence Address: CARDINAL LAW GROUP, LLC, SUITE 2000, 1603 ORRINGTON AVENUE, EVANSTON, IL, 60201, US

(73) Assignee: MOTOROLA, INC.

(21) Appl. No.: 10/324,902

(22) Filed: Dec. 20, 2002

(51) Int. Cl. G02B 6/30

(52) U.S. Cl. 385/49

(57) ABSTRACT

An optical communication between a waveguide core of an optical waveguide and a fiber core of an optical fiber is established. The fiber core is embedded within a fiber cladding with a portion of the fiber core being exposed through a section of the fiber cladding. The waveguide core is composed of refractive index material which is modified by heat or chemicals to facilitate a coupling of the waveguide core and the exposed section of the fiber core upon a pressing of the exposed section into the heated or chemically treated waveguide core.

### FIELD OF THE INVENTION

The present invention generally relates to optical coupling devices that couple light from an optical fiber to an optical waveguide and/or from the optical waveguide to the optical fiber. More specifically, the present invention relates to various configurations for such optical coupling devices, and the method for fabricating such devices.

### BACKGROUND OF THE INVENTION

Conventional methods for coupling an optical fiber to or from an optical waveguide on a carrier board (e.g., a motherboard containing the optical waveguide) require end fiber coupling of the optical fiber to the optical waveguide. As such, the optical waveguide must extend to the perimeter of the board for coupling. One drawback to this method is that the optical waveguide is relatively long due to the fact that the light must propagate towards a central region of the board where transmitters and/or sensors are generally located. The optical waveguide will typically experience a relatively high loss that results in significant reduction of optical power being transmitted to a sensor on the board. If light is propagating through a longer waveguide from an optical source on the board to the optical fiber, then less light will be received by the optical fiber from the source on board due to the higher loss. If a vertically emitting laser (“VCSEL”) is the optical source on the board, then the optical fiber is coupled in a vertical manner to the VCSEL. This is a difficult connection to make and leaves the fragile optical fiber in a position that may result in extensive bending and, perhaps, breaking of the fiber.

### SUMMARY OF THE INVENTION

The present invention advances the art by contributing an optical coupling interface that addresses the aforementioned drawbacks with the prior art.

One form of the present invention is an optical coupler device comprising an optical waveguide and an optical fiber. The optical waveguide includes a layer of refractive index material. The optical fiber includes a fiber cladding, and a fiber core embedded within the fiber cladding. A portion of the fiber core is exposed through a section of the fiber cladding. Optical communication between the exposed portion of the fiber core and the layer of refractive index material is established.

Another form of the present invention is a method for establishing the optical communication between the exposed portion of the fiber core and the layer of refractive index material. First, the layer of refractive index material is modified by applying heat or chemicals. Second, the exposed portion of the fiber core is pressed into the optical waveguide.

An additional form of the present invention is a method for establishing the optical communication between the exposed portion of the fiber core and the layer of refractive index material, which is overlying a carrier board. First, the carrier board is placed on a hot plate. Second, the hot plate is operated to apply heat to the carrier board and the layer of refractive index material. Third, the exposed portion of the fiber core is pressed into the heated layer of refractive index material.

The forgoing forms and other forms as well as features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

### BRIEF DESCRIPTION OF THE DRAWINGS

FIG. 1 illustrates a side view of one embodiment of an optical coupling device in accordance with the present invention.

FIG. 2 illustrates a top view of a second embodiment of an optical coupling device in accordance with the present invention.

FIG. 3 illustrates an end view of the optical waveguide of FIG. 2 taken along line A-A in FIG. 2.

FIG. 4 illustrates a side view of a third embodiment of an optical coupling device in accordance with the present invention.

FIG. 5 illustrates a side view of a preparation an optical fiber for use in an optical coupling device in accordance with a preparation method of the present invention.

FIG. 6 illustrates a side view of a fiber prepared for use in accordance with the preparation method of the present invention..

FIG. 7 illustrates a side view of a coupling of the optical fiber of FIG. 5 to a planar waveguide in accordance with a coupling method of the present invention the present invention.

### DETAILED DESCRIPTION OF THE PRESENTLY PREFERRED EMBODIMENTS

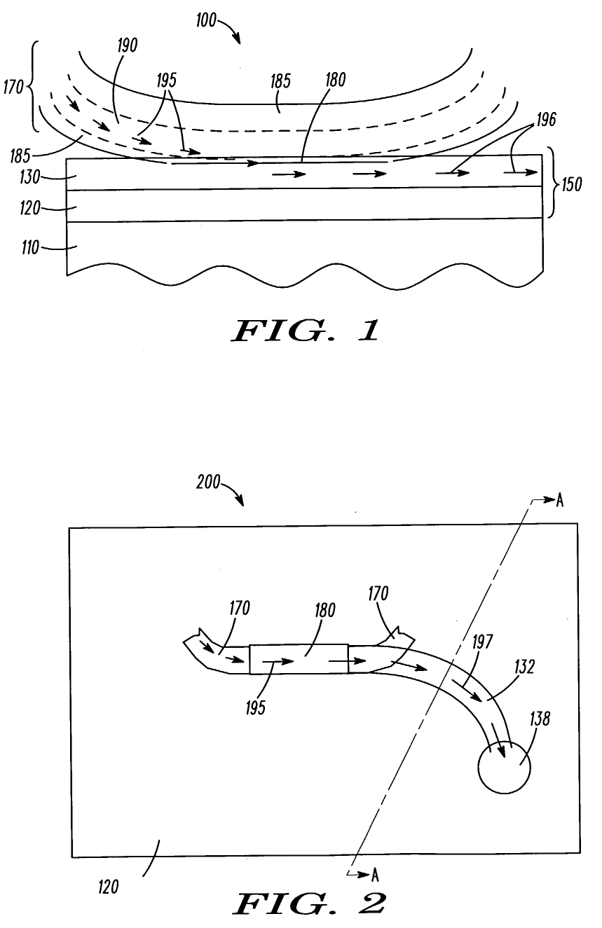

FIG. 1 illustrates a structure 100 comprising a carrier board 110, an optical waveguide 150, and an optical fiber 170. The optical waveguide 150 includes a layer 120 of refractive index material serving as the bottom cladding of the optical waveguide 150. The optical waveguide 150 further includes a layer 130 of refractive index material serving as the waveguide core of the optical waveguide 150. The bottom cladding layer 120 is conventionally deposited on the carrier board 110, and the waveguide core 130 is conventionally deposited on the waveguide cladding 120. Layers 120 and 130 can be formed from various conventional materials including, but not limited to, polymers doped polymers, oxides, and doped oxides. The refractive indices and the thickness of layers 120 and 130 determine the range of wavelengths that can propagate in the optical waveguide 150, and the mode profile of such wavelengths. In a preferred embodiment, waveguide cladding 120 is formed in polymethylmethacrylate (pmma) or acrylate, which has a refractive index of 1.49, and waveguide core 130 is formed in polystyrene, which has a refractive index of 1.59. The preferred thickness range is 10-50 m (typically 50) for waveguide cladding 120 and 8-60 m (typically 60) for waveguide core 130.

A preferred embodiment of carrier board 110 is as an organic printed wiring board. In alternative embodiments, carrier board 110 can be in the form of ceramic, inorganics, or metals.

The optical fiber 170 includes a fiber core 190 embedded in an optical fiber cladding 185. As shown in FIG. 1, waveguide core 130 and fiber core 190 are optically coupled at an interface region 180. Because of the optical coupling of the two cores 130 and 190, the mode profile of region 180 is different from the mode profile throughout other portions of waveguide core 130 and fiber core 190. The light vectors 196 in FIG. 1 illustrate one transfer of light between fiber core 190 and waveguide core 130. The actual degree of transfer will depend upon the application in which the structure 100 is used. The amount of optical power involved in the optical transfer is a function of the refractive indices of waveguide core 130 and fiber core 190 as well as the wavelength of propagating light and the geometry of the interface region 180, in particular, the geometrical length of interface region 180 along the direction of fiber core 190. The optical coupling in the illustrated embodiment can be bi-directional. Light (not shown) will typically be transferred in differing amounts from waveguide core 130 to fiber core 190, depending on the detailed design.

A slight amount of cladding left between the waveguide core 130 and fiber core 190 results in light being transmitted from waveguide core 130 to fiber core 190 by the evanescent field of the propagating mode. This cladding will generally be of the order of microns or less for efficient transfer of light from fiber core 190 to waveguide core 130. Consequently, the amount of cladding between the cores 130 and 190 must be considered when designing the structure 100 to obtain the desired transmission of optical power.

In the illustrated embodiment of FIG. 1, air forms a top cladding layer of the planar optical waveguide 150. In a further embodiment, a laterally confined waveguide can be formed by etching the layer 130 through to or part way through to the layer 120.

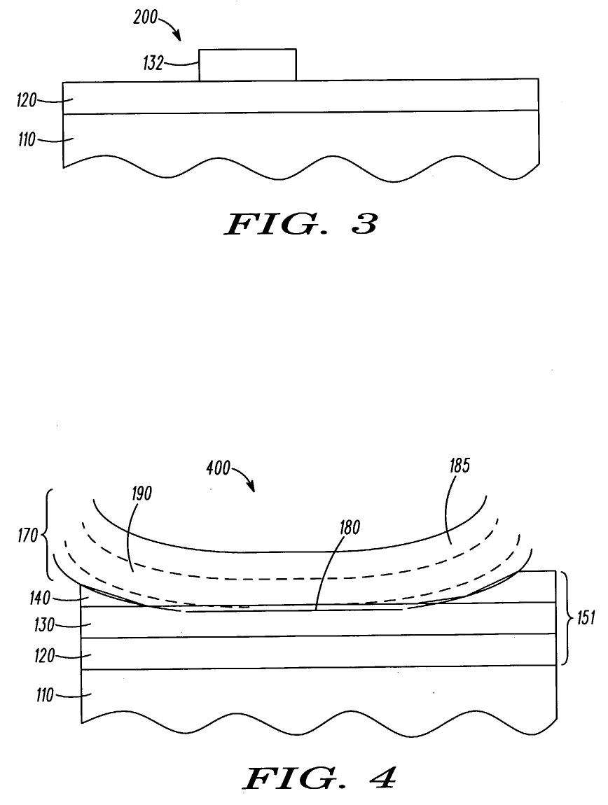

FIG. 2 illustrates a top view of a structure 200 comprising such an etched lateral waveguide core 132, and FIG. 3 illustrates structure 200 with a cross sectional view of the etched lateral waveguide core 132, through the line A-A in FIG. 2. As shown in FIG. 2, the interface region 180 allows the transfer of optical power 195,:contained in the optical fiber 170, to be transferred to a laterally confined waveguide core 132 formed on layer 120. The transferred optical power is illustrated by light vectors 197. The laterally confining waveguide core 132 has been formed by selectively etching completely through the layer 130, exposing layer 120 in all but the waveguide regions. Such lateral waveguides will typically be designed to guide light to sensors or from light sources, which may be in, on or adjacent to the carrier board 110. In a portrayal of one specific application, FIG. 2 shows a light sensor 138 receiving output light 197. This embodiment is clearly in no way limited to this specific application or any applications. The lateral dimensions will generally range from 1 to 50 m (typically 35) for the above described preferred embodiment. Depending upon the application in which the coupling device is being used, a lateral waveguide can be designed as a single mode or multimode waveguide. The optical fiber will generally be single mode if the lateral waveguide is single mode to obtain a substantial amount of optical power transfer. Likewise, the optical fiber will generally be multimode if the lateral waveguide is multimode.

Here we use the term waveguide core 132 to indicate a laterally confined waveguide. The core of a planar waveguide will be indicated by the term planar waveguide core 130.

FIG. 4 illustrates a structure 400 comprising optical fiber 170 (FIG. 1) and an optical waveguide 151, which build upon optical waveguide 150 (FIG. 1) with an addition of a layer 140 of refractive index material deposited upon layer 130 and serving as a top cladding for optical waveguide 160. In a preferred embodiment, top cladding layer 140 is formed in polymethylmethacrylate (pmma) or acrylate, which has a refractive index of 1.49, and the preferred thickness range is 10-50 m (typically 50). Prior to an optical coupling of waveguide core 130 and fiber core 190, top cladding 140 is selectively removed in the interface region area 180.

A laterally confined waveguide can be formed in the three-layer waveguide structure of FIG. 4 by selectively etching layer 140 through to or part way through to layer 130. In an additional embodiment of a waveguide with lateral confinement, layer 140 can be selectively etched through to layer 130 and layer 130 can be selectively etched through to or part way through to the layer 120. When forming an optical coupler with this latter waveguide embodiment, the exposed fiber core 190 may penetrate most of layer 140, or all of layer 140, or all of layer 140 and some of layer 130. The spacing between the fiber core 190 and the waveguide core 130 will be determined by the application and its required optical power transfer. If layer 140 is thin enough to permit evanescent coupling of the light from the fiber core 190 to the waveguide core 130, then fiber core 190 can be placed on the top of layer 140 to form the interface region 180.

As is known to those of ordinary skill in the art, for either embodiment shown in FIG. 1 or FIG. 4, the layer 120 must be thick enough to prevent leaking of the optical mode in the planar waveguide into the carrier board 110. If the layer 120 is not thick enough, the carrier board 110 may absorb the light propagating in the waveguide creating a very high loss waveguide. In the preferred embodiment, the thickness of the layer 120 will be greater than 10 m.

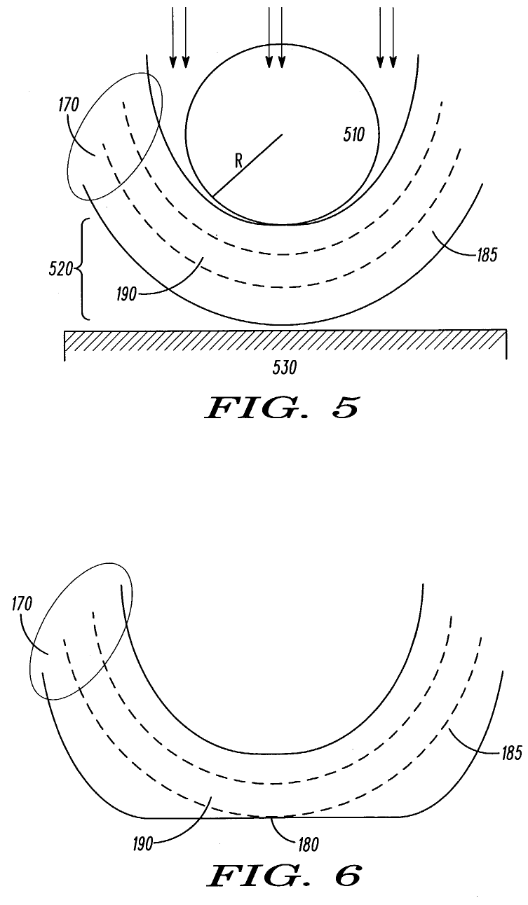

As indicated FIG. 1 and FIG. 4, a portion of the fiber core 190 must be exposed through the cladding 185 in fiber 170. FIG. 5 shows one technique of the present invention for exposing the fiber core 190 through the fiber cladding 185. The optical fiber 170 is bent around a mandrel 510 having a radius R and is held securely in that position. The bent region 520 of the optical fiber 170 is then rubbed on the polishing pad 530, wearing away a portion of the fiber cladding 185 in the bent region 520, to expose the fiber core 190 in that region. In a preferred embodiment, a Buehler Ecomet3 polisher can be used with 4000-6000 grit material in this process. Other steps of polishing off a segment of the cladding 185 to expose the fiber core 190 are known to those having ordinary skill in the art and are not described here. This method for polishing lends itself to simultaneously polishing a plurality of fibers to reduce the overall device cost. FIG. 6 illustrates a polished optical fiber 170 with an exposed fiber core 190 at interface region 180. The size and shape of the interface region 180 will be a function of the shape and size of the mandrel.

There are several ways to deposit the layers 120,130 and/or 140 including plasma deposition, spin coating, curtain coating, and vertical roller-coating. Such deposition processes are well known to those of ordinary skill in the art and will not be described in further detail here.

Laterally confined optical waveguides can be formed from the planar waveguide with a three-layer stack of FIG. 4 as described above. Layer 130 and/or layer 140 can be created by processes including reactive ion etching, direct photolithography, selective polymerization plus solvent etching of UV-curable epoxies, and selective dopant diffusion. The chosen process depends upon the material composition of carrier 110 and layers 120, 130 and 140. These processes are well known to those skilled in the art and will not be described in further detail here. Stamping of the layers with a template can be done with polymer waveguides using LIGA techniques and other techniques, which are known to those with ordinary skill in the art.

Polished optical fiber 170 is secured to the layer stack forming waveguide 150, which overlays a carrier board 110, in such a manner, which brings the exposed fiber core 190 into proximity with layer 130 at interface region 180. One method to secure optical fiber 170 to optical waveguide 150 entails heating the carrier board 110 and the overlying layers 120 and 130. One can heat the carrier board 110 and the overlaying layer stack 120 and 130, by placing the carrier board 110 on a hot plate, such as PMC720-series and setting the hot plate near the glass transition temperature, T_{g} of layer 130. For material polymethylmethacrylate, the T_{g} is 105° C., and the preferred temperature range of the hot plate is then 95° to 105° C.

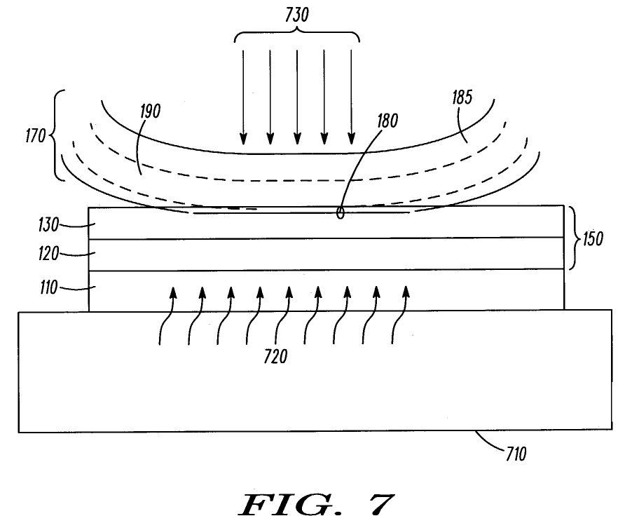

FIG. 7 shows the carrier 110 placed on a hot plate 710 with the heat transfer from the hot plate 710 indicated by the wavy lines 720. Heating will cause layer 130 to become plastic and deformable. The polished optical fiber 170 is then placed on the top surface of layer 130 with the flat exposed fiber core section of fiber core 190 parallel to the top surface of layer 130. Pressure, shown in FIG. 7 as vectors 730, is applied downward pressing the exposed fiber core section of fiber core 190 into the softened layer 130. An optical adhesive is applied to prepared fiber 170 in the interface area of 150 to maintain the mechanical attachment and alignment, and may be cured with UV light for certain adhesives, or temperature control for others. The temperature is then dropped well below the lowest T_{g} of the layer stack and the whole system is cooled to the point where all the layers in the optical waveguide 150 and the carrier board 110 are hardened. The interface of the exposed fiber core section of fiber core 190 with layer 130 is shown as 180 in FIG. 7. In region 180 the actual optical power transfer will occur, previously shown by light vectors 195 and 196 in FIG. 1 and FIG. 2. An adhesive, such as Dymax Corp. OP-64-LS (UV-cured thermoset adhesive), can be applied to the optical fiber 170, after it in the system has cooled, as a further method to secure the attachment of the optical fiber 170 to the carrier board 110.

There are other methods for heating the carrier board 110 and the overlaying layers 120 and 130, including hot air guns, ovens, etc. These methods are known to those of ordinary skill in the art and will not be discussed further.

If there is a top cladding layer 140 as shown in FIG. 4, and if the thickness of layer 140 prevents effective coupling from the exposed fiber section of fiber core 190 to layer 130, then layer 140 will need to be removed in the attachment area to allow for contact of the exposed fiber core 190 to layer 130. If the desired amount of optical coupling requires that fiber core 190 penetrate layer 130, then layer 130 must also be softened by the heating.

A second method to secure the optical fiber 170 to waveguide 150 entails chemically modifying layer 130 to facilitate an attachment of the exposed region of optical fiber 170 when the two surfaces are placed in contact with each other. Some materials which can modify pmma (polymethylmethacrylate) or acrylate are, for example, solvents such as alcohol, acetone, or gamma-Butyrolactone. Typically, the light will be carrying information for use and/or for distribution, depending upon the application in which the optical coupling device is being used. A plurality of such optical coupling devices can be formed on one carrier board 110 to allow for the coupled light to be relatively close to the point of use on the carrier board 110, reducing the distance the that light will propagate in the waveguide, thereby reducing the loss of light in the waveguide. The fabrication process taught here provides a technique of securing a plurality of coupling fibers simultaneously, reducing the fabrication cost.

Clearly, the embodiments illustrated in FIGS. 1-7 are meant to illustrate what can be fabricated for structures configured to couple light from an optical fiber to a planar or laterally confined waveguide on a carrier board and are not intended to be exhaustive of all possibilities or to limit what can be fabricated for the aforementioned purpose. There is, therefore, a multiplicity of other possible combinations and embodiments. By using what is shown and described herein, it is now simpler to couple light to and from a printed wire board containing optical waveguides. This device structure and fabrication technique allows placement of the optical coupling device at any desired section of the carrier board.

A device structure of the present invention reduces the required optical waveguide length, thus reducing the total waveguide losses. Alternatively, this device permits use of a waveguide with higher loss and shorter length for the same total loss as in a longer, prior art waveguide. In that case, one positions the coupling interface 180 (FIG. 1, FIG. 2, and FIG. 4) close to the optical sensor or source of interest. Fabrication of a waveguide with higher loss, typically, is less expensive to fabricate. Those having ordinary skill in the art will therefore appreciate the benefit of employing an embodiment of device structure 100 (FIG. 1) or an embodiment of device structure 400 (FIG. 4) for numerous and various device and systems, such as, for example, a set top box with electronics and optical components integrated on a printed circuit board.

We claim:

1. An optical coupling device, comprising:
an optical waveguide including a first layer of refractive index material; and
an optical fiber including
a fiber cladding, and
a fiber core embedded within said fiber cladding,
wherein a portion of said fiber core is exposed through a section of said fiber cladding, and
wherein said portion of said fiber core and said first layer of refractive index material are in optical communication.

2. The optical coupling device of claim 1, further comprising:
a carrier board,
wherein said first layer of refractive index material overlays said carrier board.

3. The optical coupling device of claim 1, wherein said optical waveguide further includes:
a second layer of refractive index material,
wherein said first layer of refractive index material is deposited on said second layer of refractive index material, and
wherein a first refractive index of said first layer of refractive index material is higher than a second refractive index of said second layer of refractive index material.

4. The optical coupling device of claim 3, further comprising:
a laterally confined waveguide core formed at least partially within said first layer of refractive index material.

5. The optical coupling device of claim 1, wherein said optical waveguide further includes:
a second layer of refractive index material deposited on said first layer of refractive index material, and
wherein a first refractive index of said first layer of refractive index material is higher than a second refractive index of said second layer of refractive index material.

6. The optical coupling device of claim 5, further comprising:
a laterally confined waveguide formed at least partially within said first layer of refractive index material.

7. The optical coupling device of claim 5, further comprising:
a laterally confined waveguide formed at least partially within said second layer of refractive index material.

8. The optical coupling device of claim 5,
wherein said portion of said fiber core exposed through a section of said fiber cladding extends through said second layer of refractive index material to said first layer of refractive index material.

9. The optical coupling device of claims 4, 6 or 7,
wherein said laterally confined waveguide core operates about a first optical axis,
wherein said portion of said fiber core operates about a second optical axis, and
wherein said first optical axis and said second optical axis are parallel in the region of the optical communication between said portion of said fiber core and said first layer of refractive index material.

10. A method of fabricating an optical coupling device, said method comprising:
providing an optical fiber including
a fiber cladding,
a fiber core embedded in the fiber cladding, and
a portion of the fiber core exposed-through the fiber cladding;
providing an optical waveguide including a first layer of refractive index material;
modifying the first layer of refractive index material;
contacting the exposed portion of the fiber core with the modified first layer of refractive index material whereby optical communication between the exposed portion of the fiber core and the first layer of refractive index material is established.

11. The method of claim 10, further comprising:
wrapping the optical fiber around a mandrel to form a bent region of the optical fiber; and
polishing the bent region of the optical fiber until a portion of the fiber cladding within the bent region of the optical fiber is removed from the optical fiber whereby the portion of the fiber core is exposed through the portion of the fiber cladding within the bent region.

12. The method of claim 10, further comprising:
forming a lateral confined waveguide at least partially within optical waveguide.

13. The method of claim 10, further comprising:
forming a lateral confined waveguide at least partially within the first layer of refractive index material:

14. The method of claim 10, further comprising
applying heat to the first layer of refractive index material to thereby modify the first layer of refractive index material.

15. The method of claim 10, further comprising
applying a chemical to the first layer of refractive index material to thereby modify the first layer of refractive index material.

16. A method for fabricating an optical coupling device, said method comprising:
providing a carrier board;
providing an optical waveguide including a first layer of refractive index material overlying the carrier board;
placing the carrier board upon a hot plate;
operating the hot plate to apply heat to the carrier board and the first layer of refractive index material;
providing an optical fiber including
a fiber cladding,
a fiber core embedded in the fiber cladding, and
a portion of the fiber core exposed through the fiber cladding;
pressing the exposed portion of the fiber core into the heated first layer of refractive index material whereby optical communication between the exposed portion of the fiber core and the first layer of refractive index material is established.

17. The method of claim 16, further comprising:
wrapping the optical fiber around a mandrel to form a bent region of the optical fiber; and
polishing the bent region of the optical fiber until a portion of the fiber cladding within the bent region of the optical fiber is removed from the optical fiber whereby the portion of the fiber core is exposed through the portion of the fiber cladding within the bent region.

18. The method of claim 16, further comprising:
forming a lateral confined waveguide at least partially within optical waveguide.

19. The method of claim 16, further comprising:
forming a lateral confined waveguide at least partially within the first layer of refractive index material.
